(19) United States
(12) Patent Application Publication
(10) Pub. No.: US 2003/0202136 A1
(43) Pub. Date: Oct. 30, 2003

(54) Display having front contacts and printable area

(75) Inventors: Stanley W. Stephenson, Spencerport, NY (US); Robert G. Capurso, Bergen, NY (US); John I. Kilburn, Hilton, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/134,185

(22) Filed: Apr. 29, 2002

(51) Int. Cl. G02F 1/1333

(52) U.S. Cl. 349/86

(57) ABSTRACT

A display assembly includes a display having a single flexible transparent substrate, one or more first transparent conductors located on the substrate, a layer of polymer dispersed material located over the first transparent conductor(s), the polymer dispersed material being responsive to an applied electric field for displaying information and having first and second optical states that are both stable in the absence of an electrical field, one or more second conductors located over the polymer dispersed layer for applying the electric field to the polymer dispersed material between the first and second conductors and a plurality of display contacts located on the backside of the display for making electrical connection to the first and second conductors of the display; and a support for the display, the support having a plurality of support contacts, the support contacts having a first conductive portion for providing contact to the conductors of the display and a second conductive portion in an area outside the display, the display being attached to the support with the display contacts in electrical contact with the support contacts, whereby the first and second conductors are electrically addressable from the front side of the display assembly.

### FIELD OF THE INVENTION

The present invention relates to a structure having a flexible display with front electrical contacts to the display.

### BACKGROUND OF THE INVENTION

Currently, information is displayed using assembled sheets of paper carrying permanent inks or displayed on electronically modulated surfaces such as cathode ray displays or liquid crystal displays. Other sheet materials can carry magnetically written areas carrying ticketing or financial information, however magnetically written data is not visible.

A structure is disclosed in PCT/WO 97/04398, which is a thorough recitation of the art of thin, electronically written display technologies. Disclosed is the assembling of multiple flexible display sheets that are bound into a “book”, each sheet provided with means to individually address each page. The patent recites prior art in forming thin, electronically written pages, including flexible sheets, image modulating material formed from a bi-stable liquid crystal system, and thin metallic conductor lines on each page.

U.S. Pat. No. 3,600,060 issued Aug. 17, 1971 to Churchill shows a device having a coated then dried emulsion of cholesteric liquid crystals in aqueous gelatin to form a field responsive, bistable display.

Fabrication of flexible, electronically written display sheets is disclosed in U.S. Pat. No. 4,435,047 issued Mar. 6, 1984 to Fergason. A first sheet has transparent ITO conductive areas and a second sheet has electrically conductive inks printed on display areas. The sheets can be glass, but in practice have been formed of Mylar polyester. A dispersion of liquid crystal material in a binder is coated on the first sheet, and the second sheet is pressed onto the liquid crystal material. Electrical potential applied to opposing conductive areas operates on the liquid crystal material to expose display areas. The display ceases to present an image when de-energized. Such products form electrical interconnection by offsetting the two sheets and contacting trace conductors from each of the two sheets. The displays require both front and back contact.

U.S. Pat. No. 5,751,257 issued May 12, 1998 to Sutherland shows a similar structure wherein the display has first and second substrates and the bottom substrate protrudes beyond the top substrate to provide access to conductors on the bottom substrate. Connection to a common conductor on the top substrate is provided by an extension arm having an electrical contact that makes contact with the conductor on the underside of top substrate.

The prior art typically requires multiple, separate sheets to build up the display. The electrical contacts and transparent conductive layers are typically formed through repeated vacuum deposition and photolithography of materials on the substrate. These processes are expensive and require long processing times on capital intensive equipment. Because most display structures are formed of glass, two sheets are used and are offset to permit connection to two separate and exposed sets of contacts that are disposed on separate sheets. The operative materials in such displays are unconstrained fluids, which render such displays inflexible and pressure sensitive. Such structures have both front and back contacts.

There is a need therefore for an improved display structure for providing front contact to polymer dispersed material displays. There is a further need for display assemblies to receive printed information and have sufficient flexibility to be passed through a printer.

### SUMMARY OF THE INVENTION

The need is met according to the present invention by providing a display assembly including a display having a single flexible transparent substrate, one or more first transparent conductors located on the substrate, a layer of polymer dispersed material located over the first transparent conductor(s), the polymer dispersed material being responsive to an applied electric field for displaying information and having first and second optical states that are both stable in the absence of an electrical field, one or more second conductors located over the polymer dispersed layer for applying the electric field to the polymer dispersed material between the first and second conductors and a plurality of display contacts located on the backside of the display for making electrical connection to the first and second conductors of the display; and a support for the display, the support having a plurality of support contacts, the support contacts having a first conductive portion for providing contact to the conductors of the display and a second conductive portion in an area outside the display, the display being attached to the support with the display contacts in electrical contact with the support contacts, whereby the first and second conductors are electrically addressable from the front side of the display assembly.

Advantages

The invention provides a display assembly that can be electrically accessed from the front. The display assembly can use displays manufactured through creation of layers on a single flexible substrate. Such displays having all electrical contacts behind the display can be disposed on a support to create front connections. Means are disclosed for creating support contacts on the support and connecting display conductors to the support contacts. The entire display assembly can be flexible. Display assemblies can have an adhesive backing. Multiple display assemblies can be on a common release liner to facilitate printing. The display assembly can receive images, providing static and changeable information in a single structure.

### BRIEF DESCRIPTION OF THE DRAWINGS

FIG. 1 is a perspective of a first polymer dispersed material display used with the present invention;

FIG. 2 is a schematic sectional view of a chiral nematic material in a planar and focal-conic state responding to incident light;

FIG. 3 is a top view of a second type of display useable with the present invention;

FIG. 4A is a partial cross sectional view of the display of FIG. 3 taken along line A-A at a gap in the dielectric layer;

FIG. 4B is a partial cross sectional view of the display of FIG. 3 taken along line B-B through a column trace;

FIG. 5 is a top view of a seven-segment display having the structure shown in FIG. 1;

FIG. 6A is a partial cross sectional view of the display of FIG. 5 taken along lines A-A in FIG. 5 at a gap in the dielectric layer;

FIG. 6B is a partial cross sectional view of the display of FIG. 5 taken along line B-B at a column trace;

FIG. 7A is an exploded perspective schematic view of a display assembly according to the present invention;

FIG. 7B is a perspective view of the display assembly shown in FIG. 7A, showing drive contacts in contact with the support contacts of the display assembly;

FIG. 8A is an exploded top view of a specific embodiment of a display assembly according to the present invention;

FIG. 8B is a top view of the display assembly shown in FIG. 8A;

FIG. 9A is an exploded top view of a second specific embodiment of the invention;

FIG. 9B is a top view of the assembled display assembly shown in FIG. 9A;

FIG. 10 is a partial cross sectional view of a display assembly having an adhesive backing attached to a release liner;

FIG. 11 is a partial cross sectional view of a display assembly detached from the release liner;

FIG. 12 is a partial cross sectional view of a display assembly without an adhesive backing detached from a release liner;

FIG. 13 is a partial cross sectional view of a display assembly attached to an article and being contacted by an external contact for electrically driving the display;

FIG. 14 is a schematic of an electrical drive for a display of the present invention;

FIG. 15 is a diagram showing the electrical waveforms used to drive the display of FIG. 4;

FIG. 16 is a plot of the optical state of a chiral nematic liquid crystal used in one embodiment of the present invention to electrical pulses; and

FIG. 17 is schematic diagram showing a display assembly according to the present invention, being driven by an electrical drive having row and column drivers.

### DETAILED DESCRIPTION OF THE INVENTION

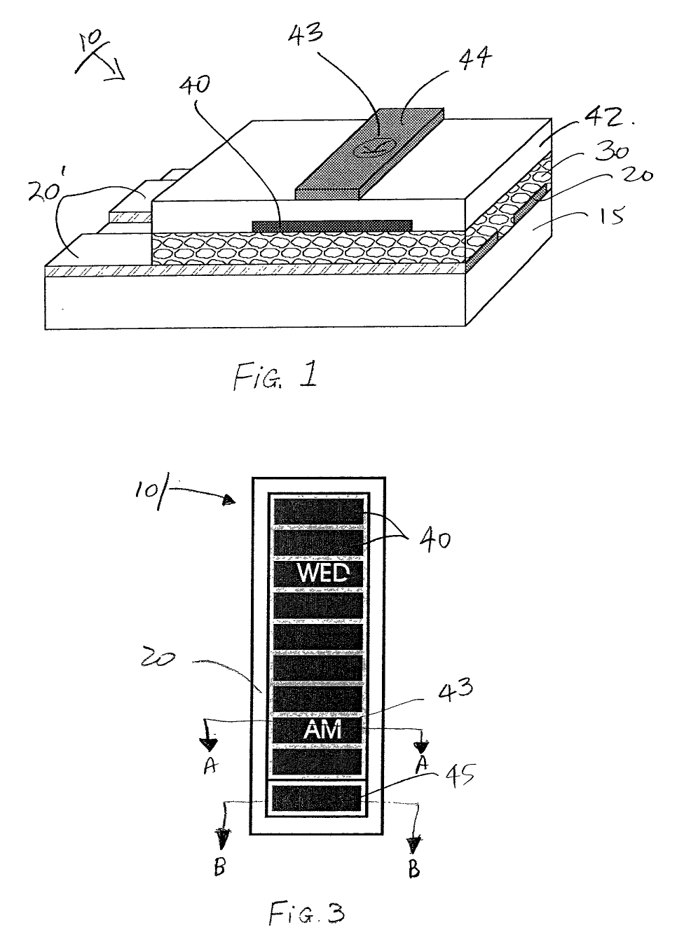

FIG. 1 is a perspective of a polymer dispersed material display generally designated 10, made in accordance with the present invention. Display 10 includes a flexible display substrate 15, which is a thin transparent polymeric material, such as Kodak Estar film base formed of polyester plastic that has a thickness of between 20 and 200 microns. In an exemplary embodiment, display substrate 15 can be a 125-micron thick sheet of polyester film base. Other polymers, such as transparent polycarbonate, can also be used.

One or more first transparent conductors 20 are formed on display substrate 15 First transparent conductors 20 can be tin-oxide, indium-tin-oxide (ITO), or polythiophene with ITO being the preferred material. Typically the material of first transparent conductors 20 is sputtered or coated as a layer over display substrate 15 having a resistance of less than 1000 ohms per square. First transparent conductors 20 can be formed in the conductive layer by conventional lithographic or laser etching means.

A layer of polymer dispersed material 30 overlays a first portion of first transparent conductor(s) 20, allowing a portion 20′ to be exposed for providing electrical contact to be made to the first transparent conductor(s). Polymer dispersed material 30 may, for example, include a polymeric dispersed cholesteric liquid crystal material, such as those disclosed in U.S. Pat. No. 5,695,682 issued Dec. 9, 1997 to Doane et al., the disclosure of which is incorporated by reference. Application of electrical fields of various intensity and duration can be employed to drive a chiral nematic material (cholesteric) into a reflective state, to a light scattering state, or an intermediate state. These materials have the advantage of having first and second optical states that are both stable in the absence of an electrical field. The materials can maintain a given optical state indefinitely after the field is removed. Cholesteric liquid crystal materials can be Merck BL112, BL118 or BL126, available from E. M. Industries of Hawthorne, N.Y. Alternative materials that can be dispersed in a polymer to provide an electrically rewritable display layer may include electrophoretic fluids or ferroelectric liquid crystals.

In a preferred embodiment, polymer dispersed material 30 is E. M. Industries' cholesteric material BL-118 dispersed in deionized photographic gelatin. The liquid crystal material is mixed at 8% concentration in a 5% gelatin aqueous solution. The mixture is dispersed to create an emulsion having 8-10 micron diameter domains of the liquid crystal in aqueous suspension. The domains can be formed using the limited coalescence technique described in Copending U.S. patent application Ser. No. 09/478,683 filed Jan. 6, 2000 by Stephenson et al., allowed Mar. 7, 2002. The emulsion is coated on a polyester display substrate over the first transparent conductor(s) and dried to provide an approximately 9-micron thick polymer dispersed cholesteric coating. Other organic binders such as polyvinyl alcohol (PVA) or polyethylene oxide (PEO) can be used in place of the gelatin. As coated and dried, without further treatment, the material is in a light reflective planar state. Such emulsions are machine coatable using coating equipment of the type employed in the manufacture of photographic films. A gel sub layer can be applied over the first conductors as described in U.S. patent application Ser. No. 09/915,441, filed Jan. 26, 2001 by Stephenson et al. A light absorbing layer such as a finely milled pigment may be applied over the dried emulsion layer as is known in the art.

Second conductors 40 overlay the layer of polymer dispersed material 30. Second conductors 40 have sufficient conductivity to induce an electric field between the first and second conductors across polymer dispersed material layer 30 strong enough to change the optical state of the polymeric material. Second conductors 40 can be formed, for example, by the well known technique of vacuum deposition for forming a layer of conductive material such as aluminum, tin, silver, platinum, carbon, tungsten, molybdenum, tin or indium or combinations thereof. The layer of conductive material can be patterned using well known techniques of photolithography, laser etching or by application through a mask. Preferably, the second conductors are light absorbing. Oxides of metals used to form the conductors can be used to make the second conductors light absorbing 40.

In a preferred embodiment, second conductors 40 are formed by screen printing a conductive ink such as Electrodag 423SS screen printable electrical conductive material from Acheson Corporation. Such screen printable conductive materials comprise finely divided graphite particles in a thermoplastic resin. Screen printing is preferred to minimize the cost of manufacturing the display.

A dielectric layer 42 can be provided over second conductors 40. The dielectric layer 42 is provided with through vias 43 that permit interconnection between second conductors 40 and conductive row contacts 44. The dielectric layer 42 can be formed, for example, by printing or coating a polymer such as vinyl dissolved in a solvent. Row contacts 44 can be formed by screen printing the same screen printable, electrically conductive material used to form second conductors 40. The row contacts 44 enable the connection of sets of second conductors 40 to create functional rows of electrically addressable areas in the polymer dispersed layer. The row contacts and the exposed portions 20′ of the first conductors 20 form a set of backside display contacts that are used as described below to electrically address the display.

The use of: a flexible support for display substrate 15; thin first transparent conductors 20; machine coated polymer dispersed cholesteric layer 30; and printed second conductors 40 permits the fabrication of a low cost flexible display that is pressure insensitive and thin enough to be attached to a support sheet and passed through a standard ink-jet printer. Small displays according to the present invention can be used as electronically rewritable tags for inexpensive, limited rewrite applications.

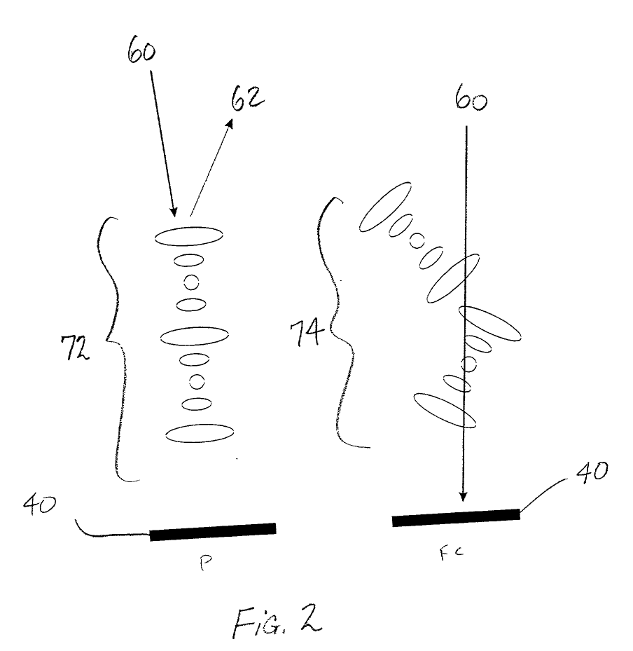

FIG. 2 is a schematic diagram of a chiral nematic material in a planar and focal-conic state responding to incident light. In the figure on the left, after manufacture or after a high voltage field has been applied and quickly switched to zero potential, the liquid crystal molecules become planar liquid crystals 72, which are reflective. In the figure on the right side of FIG. 2, upon application of a lower voltage field the molecules of the chiral nematic material break into light scattering tilted cells known as focal conic liquid crystals 74. Increasing the time duration of a low-voltage pulse progressively drives the molecules that were originally in a reflective planar state 72 towards a fully evolved and light scattering focal conic state 74.

Light absorbing second conductors 40 are positioned on the side opposing the incident light 60. In the fully evolved focal-conic state 74 the cholesteric liquid crystal is light scattering and incident light 60 is scattered to and absorbed by second conductor 40 to create the appearance of a black image. Progressive evolution towards the focal-conic state causes a viewer to perceive reflected light 62 that transitions to black as the cholesteric material changes from reflective planar state 72 to a fully evolved light scattering focal-conic state 74. When the field is removed, polymer dispersed material 30 maintains a given optical state indefinitely. The states are more fully discussed in U.S. Pat. No. 5,437,811 issued Aug. 1, 1995 to Doane et al.

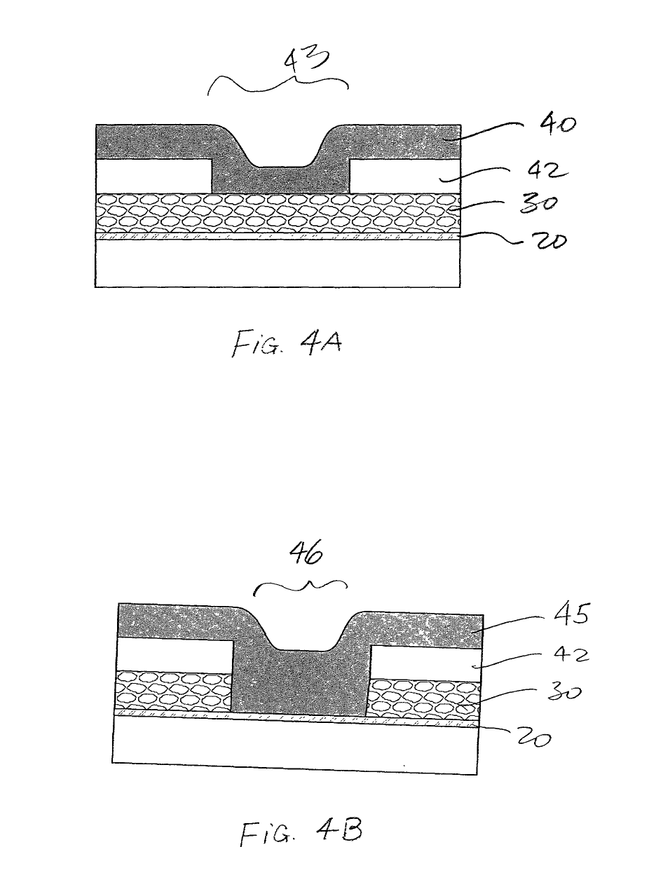

Referring to FIGS. 3, 4A and 4B, one type of display useable with the present invention will be described. In this type of display, first conductor 20 is a continuous unpatterned layer of transparent conductive material that covers the entire surface of display 10. A layer of light modulating polymer dispersed material 30 covers the first conductor 20. Dielectric layer 42 is formed for example by printing over light modulating polymer dispersed material 30, with gaps in the dielectric layer that have shapes that form indicia. The areas of the light modulating polymer dispersed layer 30 under these gaps 43 will be responsive to an electrical field formed between first and second conductors 20 and 40. Second conductors 40 are separate blocks of conductive material that cover gaps 43. To make backside contact with conductors 20, polymer dispersed material 30 is removed down to the first transparent conductor 20 and is printed over by conductive material to create a single column contact 45.

FIG. 4A is a partial cross sectional view of the display of FIG. 3 taken along line A-A at a gap 43 in the dielectric layer 42. Gap 43 is in the shape of indicia, such as an alpha-numeric character or a symbol. Dielectric layer 42 separates second conductor 40 from first conductor 20 enough so that polymer dispersed material 30 is unresponsive to an electrical field applied between first conductor 20 and second conductor 40 that is sufficient to change the state of the polymer dispersed material 30 in the absence of the dielectric layer. At gap 43, the first and second conductors 20 and 40 are in close proximity to layer 30 and can change its optical state by application of a voltage across conductors 20 and 40.

FIG. 4B is a second sectional view of the display of FIG. 3 at column contact 45. A portion of insulating layer 42 is open in this area and polymer dispersed material layer 30 is removed to expose first conductor 20 at a gap 46. Conductive material is printed over the gap to contact first conductor 20 to create a single column contact 45. The optical state of indicia are changed by applying fields to first transparent conductor 20 through column contact 45 and to individual connections to each second conductor 40.

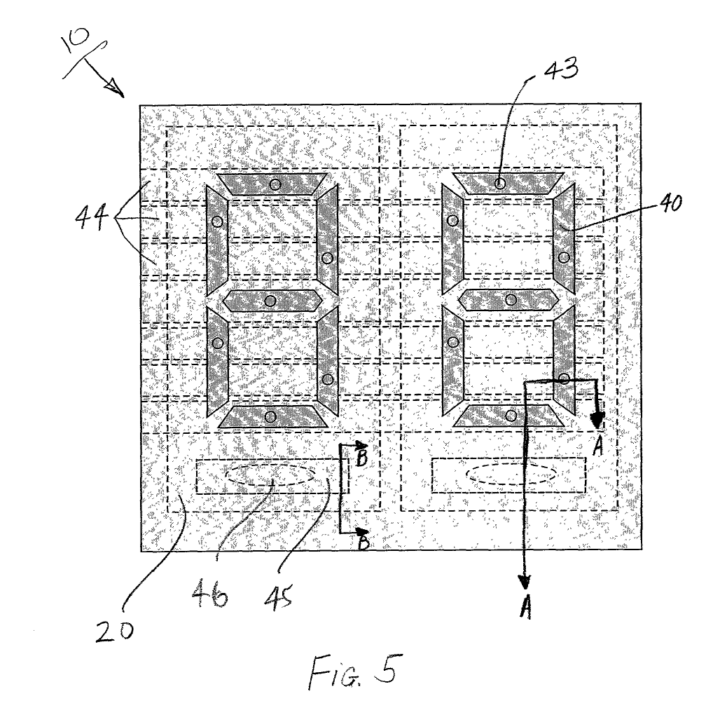

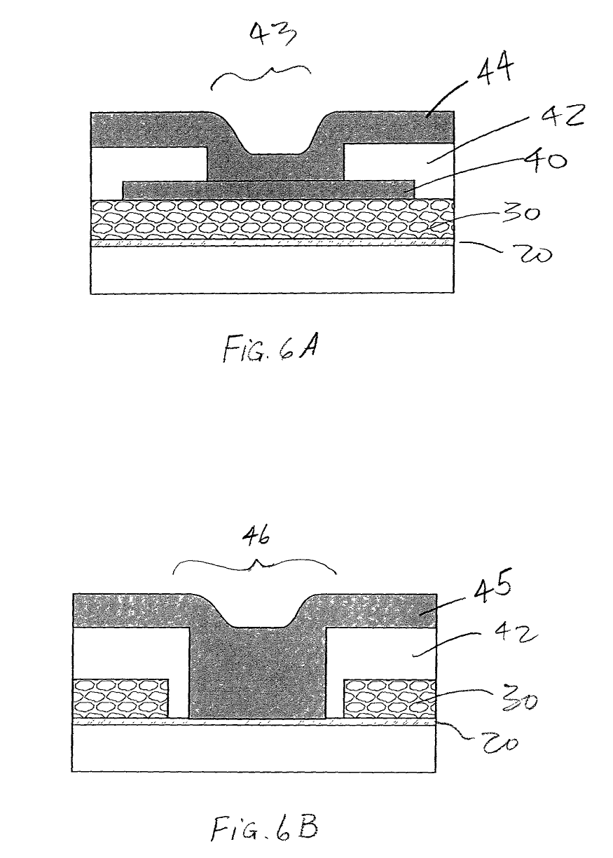

Referring to FIGS. 5, 6A and 6B, a seven-segment display useable with the present invention and having the structure shown generally in FIG. 1 will be described. First transparent conductors 20 are comprised of a patterned layer of conductive material to form one common conductor for each 7-segment character. FIG. 6A shows a partial cross sectional view of the display of FIG. 5 taken along lines A-A at a gap in the dielectric layer. Conductive material is used to print individual second conductors 40 for each segment on display 10. Dielectric layer 42 covers all of the individual second conductors 40, and gaps 43 in dielectric layer 42 allow each second conductor 40 to be connected to a printed row contact 44. Row contacts 44 connect the commonly positioned segments in all of the 7-segment characters together. FIG. 6B is a partial cross sectional view of the display of FIG. 5 taken along line B-B at a column contact. Dielectric layer 42 is open in this area and polymer dispersed material 30 have been removed at gap 46 to expose second conductor 20. Conductive material is printed over gap 46 to form column contacts 45. The completed display 10 in this embodiment includes a set of 7-segment characters connected to form a matrix display. All conductors used to write the matrix are accessible on the backside of display 10.

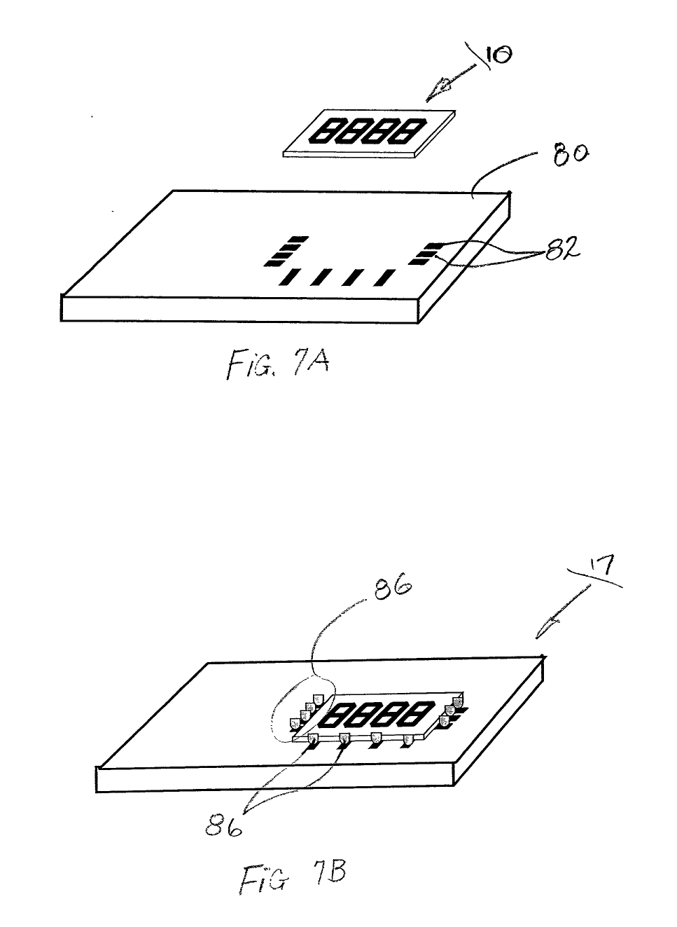

FIG. 7A is an exploded perspective view of a display assembly according to the present invention. A support 80 receives a display 10. Support 80 has areas of printed conductive ink that create support contacts 82. Support contacts 82 are positioned under each conductor on the back of display 10, and extend outside the perimeter of an attached display 10. A display 10, formed as described above is positioned over support contacts 82 and bonded to support 80 so that a portion of support contact 82 extends outside the display 10 to permit front electrical connection to display 10.

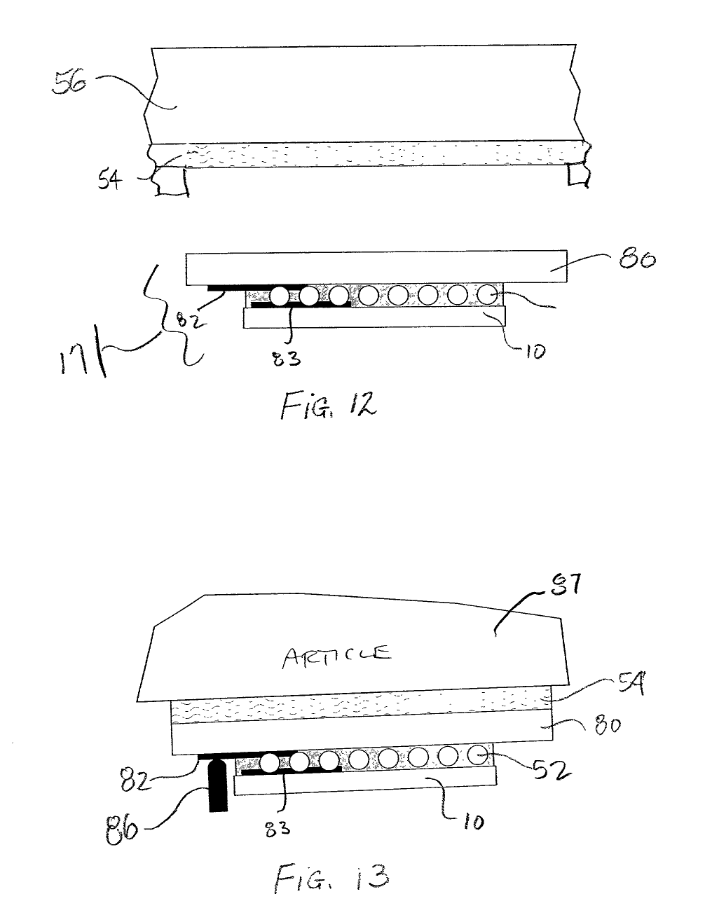

In a preferred embodiment, an anisotropic adhesive, such 3M 9703 Electrically Conductive Tape is used to fasten the display 10 to the support 80. Anisotropic adhesives provide electrical conduction through the adhesive but not across the adhesive. Referring to FIG. 10, such materials consist of conductive particles 53 having a diameter near the thickness of the adhesive binder which are dispersed at a concentration that does not result in lateral conductivity. When display 10 is pressed onto support contacts 82, conductive particles 53 form an electrical connection between display contacts 83 on the back of display 10 and support contacts 82. The anisotropic adhesive can be thermally cured with an applied pressure to provide a permanent connection between display contacts on the back of display 10 and support contacts 82. Alternatively, support contacts 82 can be undried conductive paste. Display 10 is pressed into the undried conductive paste and the paste thermally cured to provide support contacts 82 that are directly connected to display contacts 83 and to simultaneously bond the display 10 to the support 80.

FIG. 7B is a perspective view of the display assembly shown in FIG. 7A, showing drive contacts 86 in contact with the support contacts 82 of the assembled display assembly 17. A portion of each support contact 82 is exposed and receives drive contacts 86 which apply electric fields to change information on display 10. The use of cholesteric, ferroelectric liquid crystal or electrophoretic materials permits the continuing display of information after drive contacts 86 have been removed from support contacts 82.

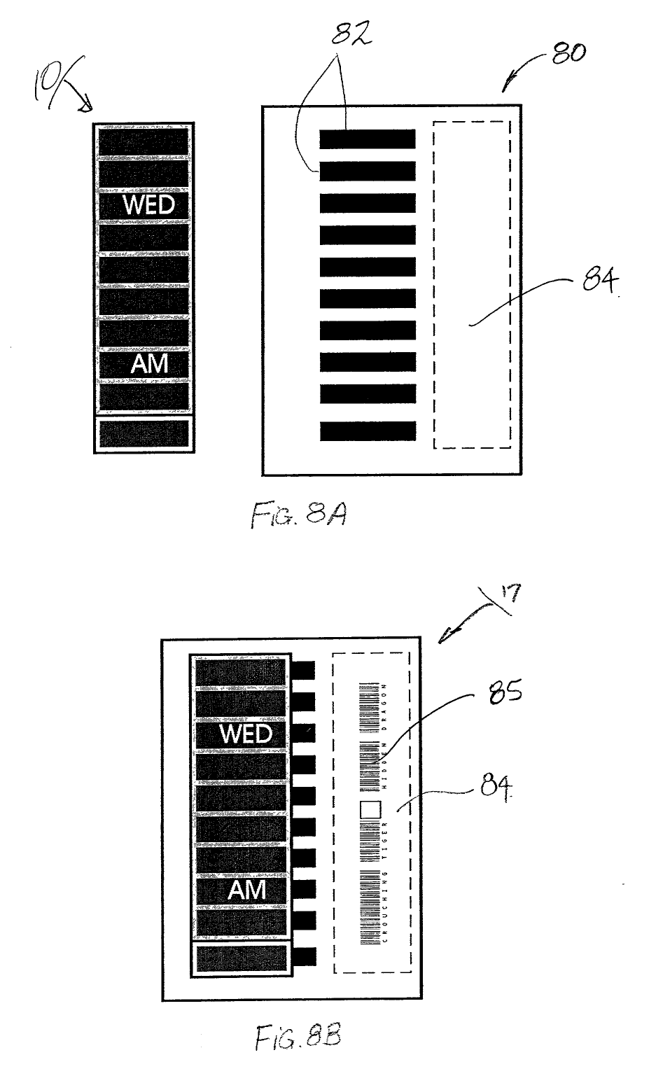

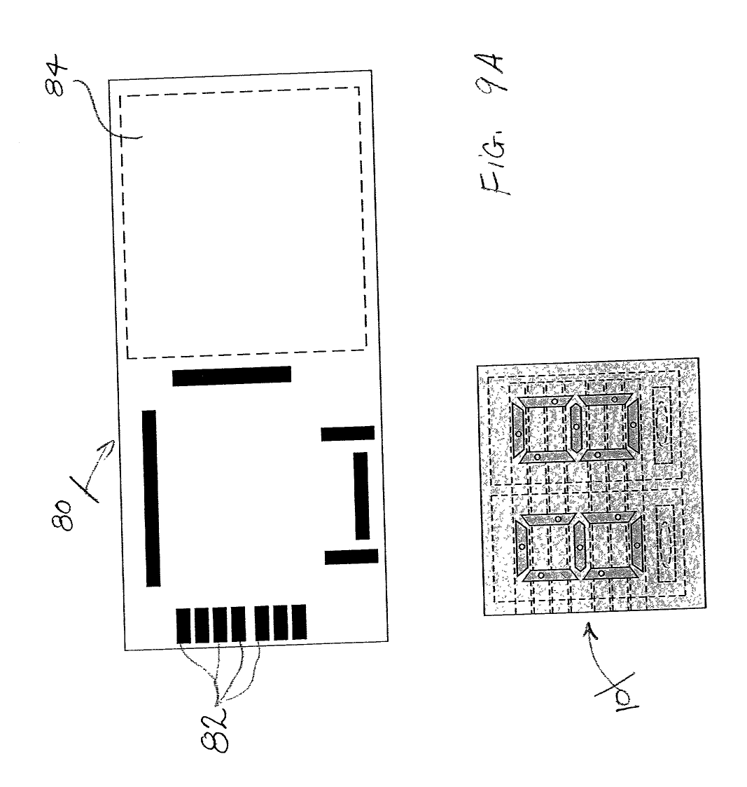

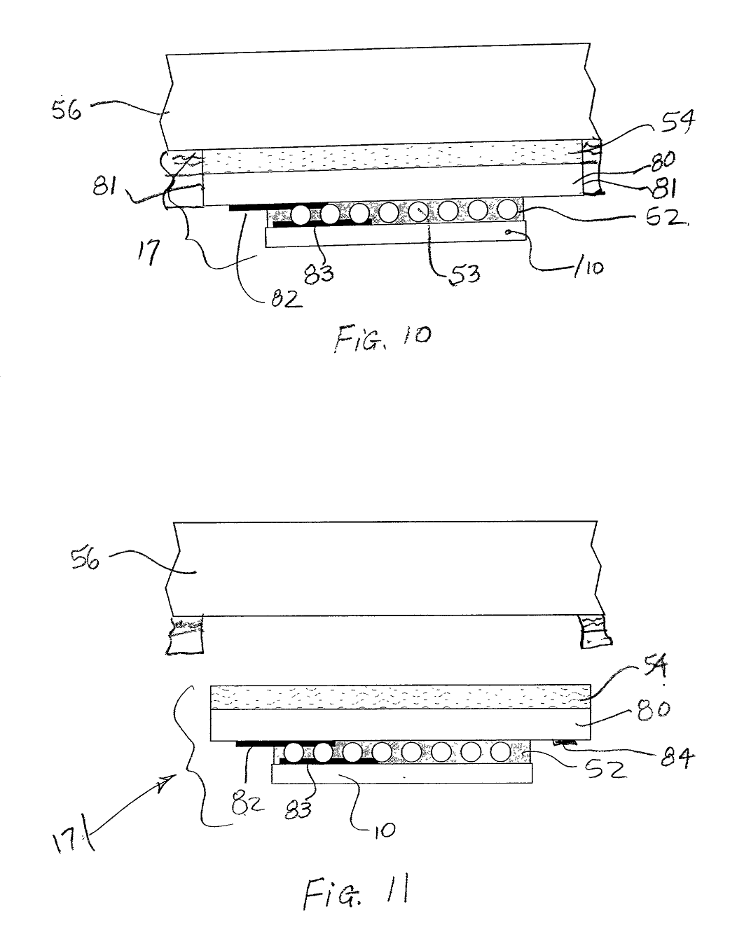

FIG. 8A is an exploded top view of one embodiment of a display assembly according to the present invention. Support 80 is a sheet of material which has been printed with support contacts 82. Support 80 can be made of paper or plastic and preferably has a printable area 84 for receiving permanent printed information. A display 10 made in accordance with the present invention is attached over printed support contacts 82 and leaves portions of support contacts 82 exposed for electrical contact.

FIG. 8B is a top view of the display assembly shown in FIG. 8A. Display assembly 17 includes display 10 bonded to support 80 in contact with support contacts 82. Display assembly 17 permits display 10 to be written using front electrical contact.

Ink jet printers are useful in printing information on the printable area 84 of the display assembly because ink jet print heads are spaced from a dye receiving surface by about 1.00 millimeter. Display 10 is typically less than 0.25 millimeters thick and is flexible, permitting display assembly 17 to pass through an ink jet printer without interfering with the motion of an inkjet head over display assembly 17. As shown in FIG. 8B, permanent, non-electrically changeable data 85 such as, but not limited to, text and bar code has been applied within printable area 84.

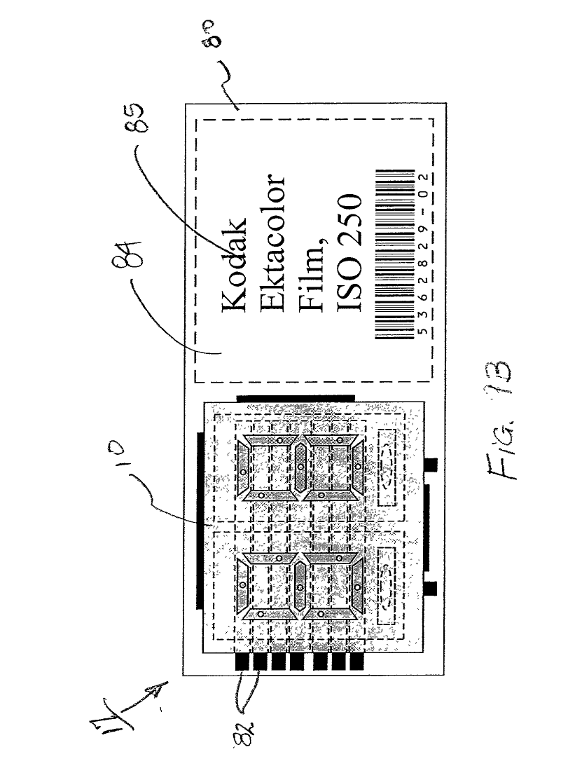

FIG. 9A is an exploded top view of an alternative embodiment of the invention. Support 80 is a sheet of material which has been printed with support contacts 82. Support 80 can be made of paper or plastic and has printable area 84 for receiving printed information. A segmented display 10 made in accordance with FIG. 5 is bonded over support contacts 82 leaving portions of support contacts 82 exposed for external front side electrical contact. FIG. 9B is a top view of the assembled display assembly shown in FIG. 9A. Display assembly 17 includes display 10 bonded to support 80 and to support contacts 82. Display assembly 17 permits display 10 to be written using front electrical contact. In FIG. 9B, data 85 has been printed within printable area 84.

An experiment was performed wherein a number of flexible displays of the type shown in FIG. 3 were bonded to a sheet of ink jet adhesive label material using an anisotropic adhesive 52. The sheet was passed through a Hewlett-Packard DeskJet 855 CSe ink jet printer and data was printed onto the label adjacent the displays. The completed display assemblies 17 were then detached from a release liner of the label material.

FIG. 10 is a partial cross sectional view of a display assembly having an adhesive backing 54 attached to a release liner 56. A number of display assemblies 17 with label adhesive backing 54 can be disposed on a sheet or roll of adhesive label material, and information can be selectively printed on each display assembly 17. In a preferred embodiment of the invention, the support 80 is die or laser cut along line 81 from a layer of support material in the adhesive label material as is known in the art.

FIG. 11 is a cross sectional view of a display assembly 17 detached from a release liner 56. Data has been written onto printable area 84 using an ink jet printer while display assembly 17 was attached to release liner 56. After ink jet printing, display assembly 17 is removed from release liner 56 for attachment to an object.

FIG. 12 is a sectional view of an alternative embodiment of a display assembly 17, wherein the adhesive layer is retained on release liner 56. Display assembly 17 has an adhesive-free back and can be held in a frame or attached to objects using other means as is well known in the art. Prior to removal from the release liner, label adhesive 54 retains display assembly 17 on the release liner 56 so that display assembly 17 can be transported for example through an inkjet printer, which can print multiple labels sequentially or simultaneously.

FIG. 13 is a partial cross sectional view of a display assembly 17 attached to an article 87 and is shown being contacted for electrical writing by drive contacts 86. Drive contacts 86 are applied to the conductive portion of support contact 82 not covered by display 10.

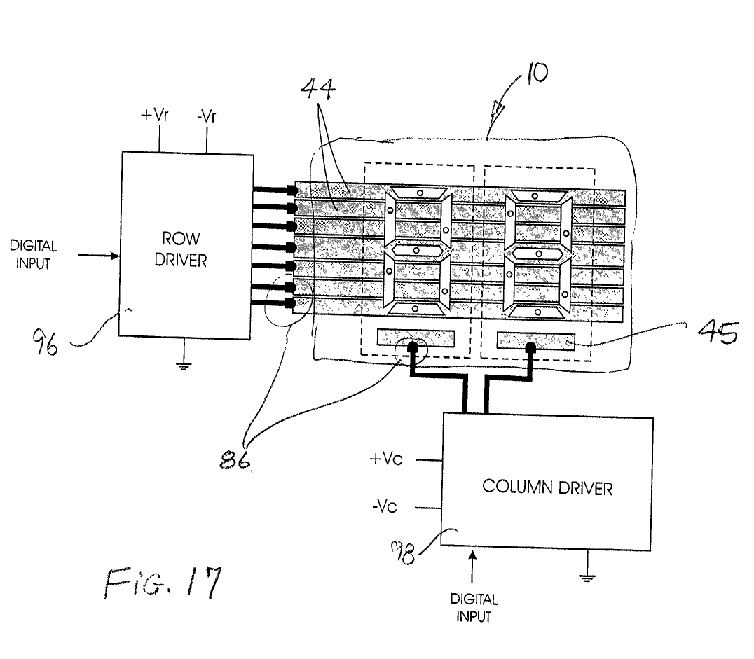

FIG. 16 is a graph of the optical response to an applied electrical field of a polymer dispersed cholesteric liquid crystal of the type useful with the present invention. Such curves can be found in above referenced U.S. Pat. No. 5,437,811. For a given pulse time, typically between 5 and 200 milliseconds, a pulse at a given voltage can change the optical state of the cholesteric liquid crystal material. Disturbance voltage V1 is the highest voltage pulse that can be applied to cholesteric material without changing the optical state of the material. Focal-Conic voltage V3 is a higher voltage pulse that drives the cholesteric liquid crystal material into the focal-conic light scattering state irrespective of the material's initial state. Planar voltage V4 is an even higher voltage that drives cholesteric material into the planar, reflective state irrespective of the cholesteric material's initial state.

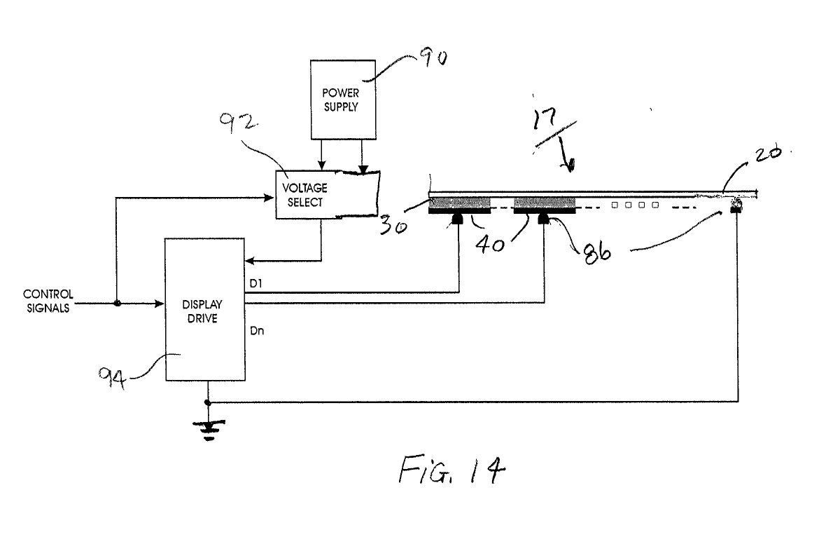

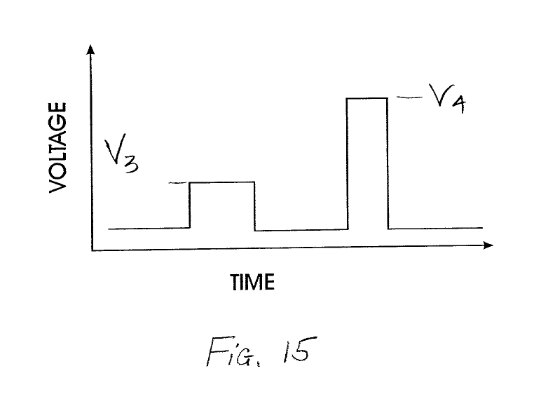

Using the optical response shown in FIG. 16, displays of the type shown in FIG. 8B having a common first conductor 20 and an individual second conductor 40 for each element of the display can be driven by an electrical drive circuit of the type shown in FIG. 14. For simplicity, drive contacts 86 are shown connected directly to first and second conductors 20 and 40, it being understood that actual contact is made by exposed portions of support contacts 82 on the front of display assembly 17. In FIG. 8B, the rightmost drive contact 86 is connected to second conductor 20 and is connected to ground. Each of the remaining drive contacts 86 is connected to one of the second conductors 40.

Power supply 90 generates two voltages, a higher planar driving voltage and a lower focal-conic voltage. A voltage select circuit 92 is used to select one of the two voltages. Voltage select circuit 92 can be, for example, a resistor network and a switching transistor. Control signals are applied to the voltage select circuit 92 and also to a display driver 94. Display driver 94 is used to apply the selected voltage to appropriate segments of the display assembly 17. In this way the circuitry selectively addresses the different segments to cause them to assume the appropriate optical state for the information being written to the display. Display driver 94 applies the selected voltage from voltage selector 92 to drive contacts 86. Display driver 94 can for example be embodied in a commercially available device known as HV57908PG from Supertex Inc. of Sunnyvale, Calif.

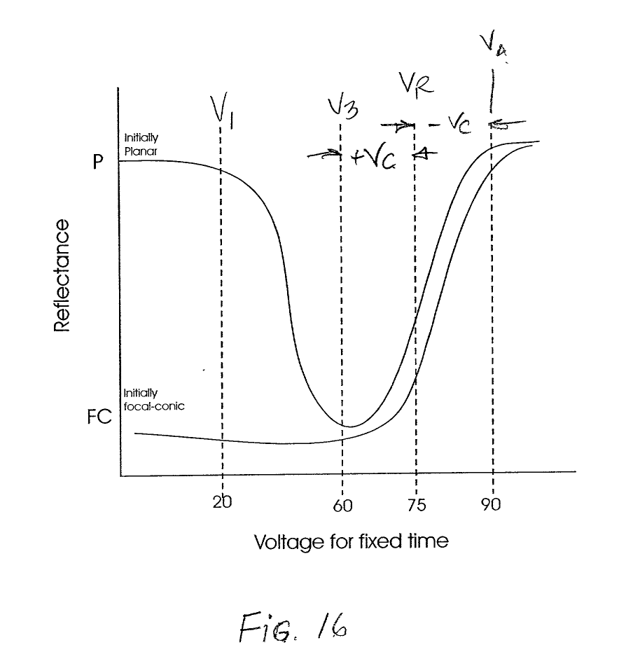

FIG. 15 is a diagram of the voltage waveform applied by display driver 94 to drive display 10. Voltage select circuit 92 is first set to the lower, focal-conic voltage V3 and all contacts 86 connected to second conductors 40 receive a pulse of the lower focal-conic voltage V3 to set all of the elements of the display 10 to the light scattering focal-conic state. Voltage select circuit 92 is then set to apply a higher planar voltage V4 to display driver 94. Display driver 94 then applies planar voltage V4 to selected second conductors 40 corresponding to segments that are to be placed in the reflective, planar state. Those segments that are to remain in the light scattering state do not receive a V4 voltage pulse. The waveform in FIG. 15 shows the sequence of voltages that are used to place the elements of the display into the reflective planar state. Areas under the second conductors that do not receive the second pulse V4 are left in the light scattering state, and represent the information being written to the display. The drive method is a simple method of erasing and re-writing display 10. Information continues to be displayed after drive contacts 86 have been removed from support contacts 82.

Using the optical response shown in FIG. 16, displays of the type shown in FIG. 9B having a matrix array of first and second conductors can be driven as follows. Sequentially, a row voltage Vr is set midway between V3 and V4 on a selected row while the remaining rows are set to a ground voltage. A positive or negative column voltage Vc is set across all columns to offset Vr to either focal conic voltage V3 or planar voltage V4, depending on the desired final state of a row of pixels. The positive and negative column voltages Vr−V3 and V4−Vr are less than disturbance voltage V1 so that rows at ground potential experience voltages less than disturbance voltage V1 and are not changed. This writing technique permits sequential row writing.

FIG. 17 is an electrical schematic of an electrical drive for a display of the type shown in FIG. 9B. Four power supplies and a ground are used to supply +Vc, −Vc, +Vr, −Vr and ground. Separate drive chips, row driver 96 and a column driver 98, are employed to apply the row and column voltages to the selected conductors. Drive contacts 86 connect row driver 96 to row contacts 44 on display 10, and additional drive contacts 86 connect column driver 98 to column contacts 45. Digital data is fed to row driver 96 and column driver 98. A set of shift registers (not shown) in the drivers receives and latches binary state data.

A bipolar row voltage Vr can be applied to a selected row, while a bipolar column voltage Vc is applied either in phase or out of phase with the row voltage VR. If the bipolar voltages are out of phase, the pixel will experience alternating bipolar high pixel voltage Vp corresponding to V4 and be written into the planar state (P). If the two voltages are in phase, then a pixel experiences lower alternating bipolar pixel voltage Vp corresponding to V3 and is written into the focal conic state (FC). Columns 47 held at a ground state (0) experience a bipolar alternating column voltage Vc as an alternating AC field equivalent to half the voltage difference between V4 and V3. Column voltage is less than disturbance voltage V1 to preserve the image state of unwritten, grounded rows. Each row is written until new information has been written to display assembly 17. Information continues to be displayed after drive contacts 86 have been removed from support contacts 82.

Alternatively, a dynamic drive scheme such as that disclosed the article “Simple Drive Scheme for Bistable Cholestric LCDs” by A Rybalochka, et al. in SID 01 Digest p.882-885.

The invention has been described in detail with particular reference to certain preferred embodiments thereof, but it will be understood that variations and modifications can be effected within the spirit and scope of the invention.

Parts List

10 display

15 display substrate

17 display assembly

20 first transparent conductors

20 ′ exposed portions of first conductors

30 light modulating polymer dispersed material

40 second conductors

42 dielectric layer

43 gap

44 row contacts

45 column contact

46 gap

52 anisotropic adhesive

53 conductive particles

54 label adhesive

56 release liner

60 incident light

62 reflected light

72 planar liquid crystal

74 focal conic liquid crystal

80 support

81 cut line

82 support contacts

83 display contacts

84 printable area

85 changeable data

86 drive contacts

87 article

90 power supply

92 voltage select

94 display driver

96 row driver

98 column driver

V1 disturbance voltage

V3 focal conic voltage

V4 planar voltage

Vc column voltage

Vr row voltage

What is claimed is:

1. A display assembly, comprising:
a) a display including a single flexible transparent substrate, one or more first transparent conductors located on the substrate, a layer of polymer dispersed material located over the first transparent conductor(s), the polymer dispersed material being responsive to an applied electric field for displaying information and having first and second optical states that are both stable in the absence of an electrical field, one or more second conductors located over the polymer dispersed layer for applying the electric field to the polymer dispersed material between the first and second conductors and a plurality of display contacts located on the backside of the display for making electrical connection to the first and second conductors of the display; and
b) a support for the display, the support having a plurality of support contacts, the support contacts having a first conductive portion for providing contact to the conductors of the display and a second conductive portion in an area outside the display, the display being attached to the support with the display contacts in electrical contact with the support contacts, whereby the first and second conductors are electrically addressable from the front side of the display assembly.

2. The display assembly of claim 1 wherein the support and/or display contacts are carbon in a polymer binder.

3. The display assembly of claim 1 wherein the display is attached to the support by an anisotropic electrically conductive adhesive providing electrical connection between the display and support contacts.

4. The display assembly of claim 1, further including an adhesive on the back of the support.

5. The display assembly of claim 1 wherein the support further includes an area for receiving printed images.

6. The display assembly of claim 1, wherein the polymer dispersed material comprises a cholesteric liquid crystal.

7. The display assembly of claim 1, wherein the polymer dispersed material is a dried emulsion of cholesteric liquid crystal in gelatin.

8. The display assembly of claim 1, wherein the display includes display elements that form a segmented numeric display.

9. The display assembly of claim 1, wherein the display includes display elements that are icons, words or alphanumeric characters.

10. The display assembly of claim 1, wherein support is an ink jet print medium.

11. The display assembly of claim 10, wherein the ink jet print medium is an adhesive label material.

12. The display assembly of claim 11, wherein the adhesive label material is die or laser cut to define the support.

13. An article, comprising a plurality of display assemblies claimed in claim 4 on a release liner.

14. An article comprising a plurality of display assemblies claimed in claim 9 on a release liner.

15. A method of making a display assembly comprising the steps of:
a) providing a support for mounting a display;
b) forming a plurality of support contacts on the support, the support contacts having a first conductive portion for providing contact to conductors of a display mounted on the support and a second conductive portion in an area outside the display from the front of the display assembly;
c) providing a display having a single flexible transparent substrate, one or more first transparent conductors located on the substrate, a layer of polymer dispersed material located over the first conductor(s), the polymer dispersed material being responsive to an applied electric field for displaying information and having first and second optical states that are both stable in the absence of an electrical field, one or more second conductors located over the polymer dispersed layer for applying the electric field to the polymer dispersed material between the first and second conductors and a plurality of display contacts located on the backside of the display for making electrical connection to the first and second conductors of the display; and
d) attaching the display to the support such that the display contacts are in electrical contact with the support contacts, whereby the first and second conductors are electrically addressable from the front side of the display assembly.

16. The method claimed in claim 15, wherein the support further includes an area for receiving printed images.

17. The method claimed in claim 16, further comprising the step of printing an image on the support.

18. The method claimed in claim 17, wherein the support is inkjet print media, and the printing is performed by an ink jet printer.

19. The method claimed in claim 18, wherein the support is adhesive label material and a plurality of display assemblies are provided on a sheet of the adhesive label material.

20. The method of claim 19, wherein the adhesive label material is die or laser cut to define the support.

21. The method claimed in claim 15, wherein the plurality of contacts are applied to the support by printing conductive ink.

22. The method claimed in claim 21, wherein the conductive ink is carbon in a polymer binder.

23. The method claimed in claim 21, wherein the display is attached to the support by the conductive ink.

24. The method claimed in claim 15, wherein the display is attached to the support by an anisotropic conductive adhesive providing electrical connection between the conductors of the display and the contacts on the support..

25. The method claimed in claim 15, wherein the support has an adhesive backing.

26. The method claimed in claim 15, wherein the polymer dispersed material comprises cholesteric liquid crystal.

27. The method claimed in claim 15, wherein the polymer dispersed material is a dried emulsion of cholesteric liquid crystal in gelatin.
